(19) United States
(12) Patent Application Publication
(10) Pub. No.: US 2006/0167936 A1
(43) Pub. Date: Jul. 27, 2006

(54) Data processing device

(76) Inventors: Osamu Okauchi, Hirakata-shi, Osaka (JP); Kazuhiko Nakamura, Hirakata-shi (JP); Masanori Ito, Moriguchi-shi (JP)

Correspondence Address: MARK D. SARALINO (MEI);RENNER, OTTO, BOISSELLE & SKLAR, LLP, 1621 EUCLID AVENUE, 19TH FLOOR, CLEVELAND, OH, 44115, US

(21) Appl. No.: 10/549,270

(22) PCT Filed: Mar. 25, 2004
(86) PCT No.: PCT/JP04/04227

§ 371 Date: Sep. 13, 2005

(30) Foreign Application Priority Data
Mar. 27, 2003 (JP) 2003-088453

(51) Int. Cl. G06F 17/00; G06F 7/00

(52) U.S. Cl. 707/104.1

(57) ABSTRACT

A data processor transfers a data stream, which is stored on a storage medium, to a connected device. The data stream includes attribute information that specifies the format of the data stream. The data processor includes: an interface section, which communicates with the device to acquire format information about a format that is compatible with the device; a reading section for reading the attribute information and the data stream from the storage medium; a reading control section for determining, by the attribute information and the format information, whether or not the format of the data stream needs to be converted; and a converting section for outputting the data stream either after having converted the format of the data stream into the one specified by the format information or without converting the format of the data stream as determined by the reading control section. The interface section transmits the data stream, which has been output from the converting section, to the device.

### TECHNICAL FIELD

The present invention relates to processing of transferring a data stream concerning video and/or audio between multiple devices.

### BACKGROUND ART

Recently, apparatuses that can record and play compressed and encoded digital data streams, concerning contents such as video and/or audio, on/from a storage medium such as an optical disk have become more and more popular. Most of those apparatuses record those data streams on a storage medium so as to comply with a predetermined standard (i.e., a recording format) and ensure playback compatibility between apparatuses. Taking a DVD as one of various optical disks as an example, there are a number of standards for recording a data stream on a DVD. Examples of those standards include the DVD Video standard (which will be simply referred to herein as “Video standard”) and the DVD Video Recording standard (which will be simply referred to herein as “VR standard”). The Video standard defines a recording format for a package medium on which a read-only data stream such as a movie is stored. Meanwhile, the VR standard defines a recording format for recording a data stream in real time and making it editable afterward.

A recorder on the market cannot always record a data stream so as to comply with every currently effective standard. Thus, an appropriate standard is selected for the recorder according to its purpose, price range or any other criterion. The recorder normally can neither analyze nor record a data stream that does not comply with its own standard.

Suppose two optical disk drives are connected together such that a data stream is output from one of the two drives (which will be referred to herein as a “drive on the transmitting end”) and the other drive (which will be referred to herein as a “drive on the receiving end”) records it on a storage medium. This is what they call a “data stream transfer (copying) process”. A data stream compliant with the VR standard is supposed to be stored on an optical disk in the drive on the transmitting end. On the other hand, the drive on the receiving end is supposed to record a data stream only in compliance with the Video standard.

In that case, even if the drive on the transmitting end outputs the VR-compliant data stream as it is to the drive on the receiving end, the drive on the receiving end can neither analyze the data stream nor record it on a storage medium. That is why the drive on the transmitting end converts the VR-compliant data stream into a Video-compliant data stream and then outputs it to the drive on the receiving end. Then, the drive on the receiving end can record the received Video-compliant data stream on a DVD as it is (i.e., without processing the data stream).

However, it takes a lot of time to complete this conventional transfer process (i.e., there is a long delay from the start to the end of the transfer process). This is because the drive on the transmitting end restructures the entire data stream such that the resultant data stream will comply with the recording format of the drive on the receiving end. As used herein, the “data stream restructuring” means a process of decoding a VR-compliant data stream and then re-encoding it such that the resultant data stream complies with the Video standard. In this case, even if it is actually unnecessary to restructure the data stream, the conventional drive on the transmitting end always restructures the entire data stream while reading it as in normal playback operation; thus taking a long time to complete the transfer process.

Also, if the drive on the transmitting end can process moving picture streams that are compliant with multiple standards, then the drive on the transmitting end needs to sense what standard the given data stream is compliant with and then determine whether or not the data stream needs to be converted. In that case, it takes an even longer time to complete the transfer process.

Thus, an object of the present invention is to identify the standard that a given data stream is compliant with and transfer the data stream at high speed between multiple devices.

### DISCLOSURE OF INVENTION

A data processor according to the present invention transfers a data stream, which is stored on a storage medium, to a connected device. The data stream includes attribute information that specifies the format of the data stream. The data processor includes: an interface section, which communicates with the device to acquire format information about a format that is compatible with the device; a reading section for reading the attribute information and the data stream from the storage medium; a reading control section for determining, based on the attribute information and the format information, whether or not the format of the data stream needs to be converted; and a converting section for outputting the data stream either after having converted the format of the data stream into the one specified by the format information or without converting the format of the data stream as determined by the reading control section. The interface section transmits the data stream, which has been output from the converting section, to the device.

In the data stream, the attribute information, as well as copied management information, may be stored on the storage medium. The reading section may read the management information and extract the attribute information.

The reading section may read the data stream and extract the attribute information.

The reading section may change the read rates of the data stream depending on whether or not the format needs to be converted.

The reading section may read the data stream at a first rate if the format needs to be converted, but read the data stream at a second rate, which is higher than the first rate, if the format need not be converted.

A data processing method according to the present invention is carried out by a data processor for transferring a data stream, which is stored on a storage medium, to a device that is connected to the data processor. The data stream includes attribute information that specifies the format of the data stream. The method includes the steps of: communicating with the device to acquire format information about a format that is compatible with the device; reading the attribute information and the data stream from the storage medium; determining, based on the attribute information and the format information, whether or not the format of the data stream needs to be converted; and outputting and transmitting the data stream to the device either after having converted the format of the data stream into the one specified by the format information or without converting the format of the data stream in accordance with the result of the step of determining.

In the data stream, the attribute information, as well as copied management information, may be stored on the storage medium. The step of reading may include reading the management information and extracting the attribute information.

The step of reading may include reading the data stream and extracting the attribute information.

The step of reading may include changing the read rates of the data stream depending on whether or not the format needs to be converted.

The step of reading may include reading the data stream at a first rate if the format needs to be converted, but reading the data stream at a second rate, which is higher than the first rate, if the format need not be converted.

### BRIEF DESCRIPTION OF DRAWINGS

FIG. 1(a) illustrates a camcorder 10 and a DVD recorder 20 that are connected together so as to transfer a data stream.

FIG. 1(b) shows examples of combinations of data streams A and B with their relative lengths of transfer times according to a preferred embodiment of the present invention.

FIG. 2 shows an arrangement of functional blocks in a data processor 10 according to a preferred embodiment of the present invention.

FIG. 3 shows the data structures of a moving picture file 12 and a management file 14 that are stored on an optical disk 131.

FIG. 4 shows a more detailed data structure of the moving picture stream 11.

FIG. 5(a) shows the data structure of an auxiliary information pack 40.

FIG. 5(b) shows correspondence between the ID of attribute information 52 and the contents of attribute data U_PK_data 53 described according to the ID.

FIG. 6 shows the types of IDs described in the U_PK attribute information box 19 and their associated types of U_PK stored data

FIG. 7 is a flowchart showing the procedure of a transfer process to be done by the data processor 10.

### BEST MODE FOR CARRYING OUT THE INVENTION

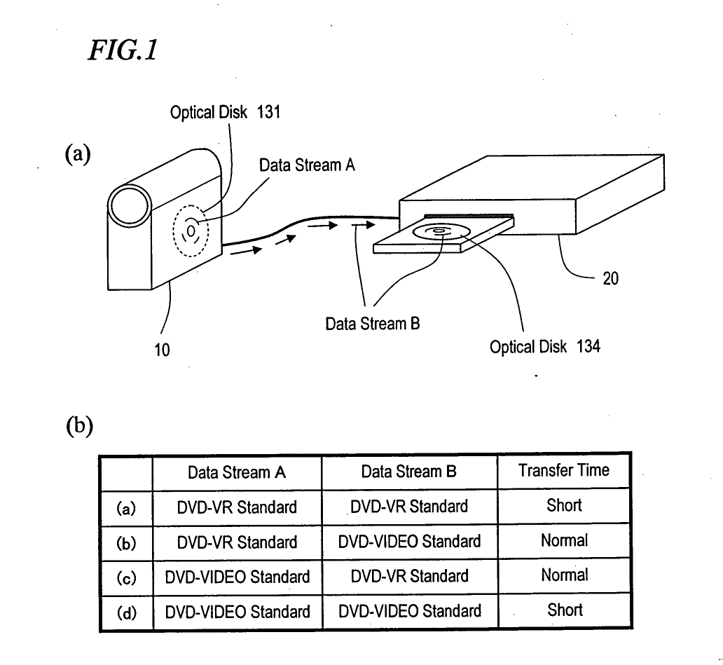

Hereinafter, processing according to the present invention will be described with reference to FIGS. 1(a) and 1(b) first, and then the configuration and operation of a data processor that carries out the processing will be described.

FIG. 1(a) illustrates a camcorder 10 and a DVD recorder 20 that are connected together so as to transfer a data stream. In the example shown in FIG. 1(a), the data stream is supposed to be transferred from the camcorder 10 to the DVD recorder 20.

The camcorder 10 shoots video and audio and stores a moving picture file as data stream A on an optical disk 131 loaded inside. As the recording format, one of the DVD-VR standard and the DVD-Video standard is selected responsive to the user's operation, for example. In the data stream A, attribute information, specifying the format of the data stream A, is provided at a predetermined location to be described later.

Also, the camcorder 10 communicates with the DVD recorder 20 to acquire the format information of the DVD recorder 20. As used herein, the “format information” is a piece of information specifying the format that can be processed by the DVD recorder 20. The DVD recorder 20 is supposed herein to be able to record a data stream in the format defined by either the VR standard or the Video standard. When the DVD recorder 20 connected is identified, its format will be known by itself, too. In the example shown in FIG. 1(a), the data stream that can be recorded by the DVD recorder 20 on an optical disk 134 is referred to as “data stream B”.

On reading the moving picture file, representing the data stream A and also including the attribute information, from the optical disk 131, the camcorder 10 compares that attribute information to the format information, thereby determining whether or not the format of the data stream A should be converted. That is to say, if the data stream A has a format that makes it recordable by the DVD recorder 20, then the camcorder 10 decides that the format conversion need not be done. Otherwise, the camcorder 10 decides that the format conversion should be done.

If the camcorder 10 has decided that the format conversion need not be done, then the camcorder 10 outputs the data stream A as the data stream B without processing the data stream A. In response, the DVD recorder 20 receives the data stream B and records it as it is on the optical disk 134.

On the other hand, if the camcorder 10 has decided that the format conversion should be done, then the camcorder 10 converts the format of the data stream A into one specified by the format information and then outputs the resultant stream as the data stream B. In response, the DVD recorder 20 receives the data stream B and records it as it is on the optical disk 134.

FIG. 1(b) shows examples of combinations of data streams A and B with their relative lengths of transfer times according to this preferred embodiment. The combination (a) shows an exemplary situation where both of the data streams A and B comply with the VR standard, while the combination (d) shows an exemplary situation where both of the data streams A and B comply with the Video standard. In these two situations, the data stream can be transferred in a relatively short time. The reason is that since no format conversion is necessary, the data stream A can be read and output from the optical disk 131 at a read rate that is several to several tens of times as high as a normal read rate.

On the other hand, the combinations (b) and (c) show situations where the data streams A and B have mutually different formats. In these two situations, the transfer time of the data stream becomes as long as the conventional one (which is shown as “normal” in FIG. 1(b)) because it takes a lot of time to get the conversion done and the data stream A cannot be read out quickly from the optical disk 131 due to the conversion.

Next, the configuration of the camcorder 10 will be described. In the following description, however, the camcorder 10 will be referred to herein as a “data processor 10” to describe its configuration more generally. That is to say, the camcorder described above is one typical embodiment of the data processor 10. However, a device having the following functions falls within the range of the data processor of the present invention even if that device is not a camcorder.

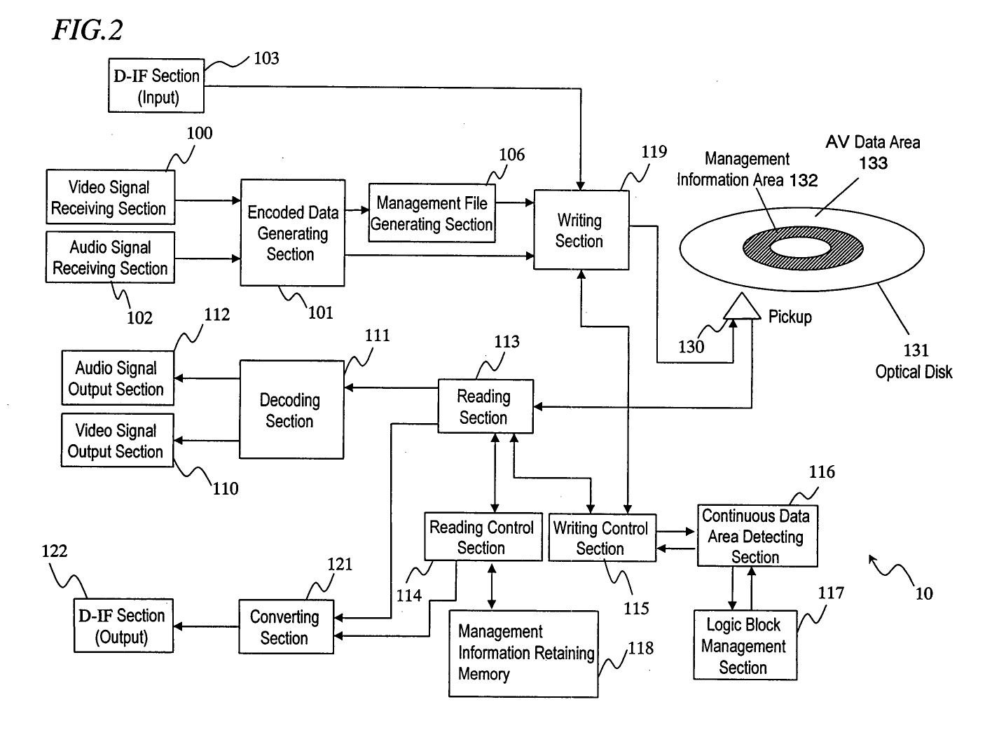

FIG. 2 shows an arrangement of functional blocks for a data processor 10 according to this preferred embodiment. The data processor 10 writes a data stream on an optical disk 131 as an exemplary storage medium. The optical disk 131 may be a DVD-RAM disk, for example. The optical disk is not an essential component for the data processor 10 but is shown in FIG. 1 for convenience sake. The data processor 10 is actually made up of the other components shown in FIG. 1. An example in which the storage medium is an optical disk 131 will be described herein. However, the same statement equally applies to even a situation where a semiconductor storage medium such as a memory card is used, for example.

The data processor 10 has the three functions of recording, playing back and transferring a data stream. More specifically, the recording function is a function of the data processor 10 that receives a digital or analog signal concerning video and/or audio and writes a data stream, obtained from the signal, on the optical disk 131. The playback function is another function of the data processor 10 that reads the data stream stored on the optical disk 131 to play back the video and/or audio. And the transfer function is another function of the data processor 10 that transfers the data stream, stored on the optical disk 131, to an external device. In transferring the data stream, the data processor 10 determines whether or not the format of the stream should be converted. If the format conversion is necessary, then the data processor 10 reads the data stream at a standard rate, converts the data stream into a format that can be processed by the external device connected, and then outputs the resultant stream. On the other hand, if the format conversion is unnecessary, then the data processor 10 reads the data stream from the optical disk 131 at a high rate and outputs it as it is to the external device.

The main function of the data processor 10 of this preferred embodiment is the function of transferring a data stream. Hereinafter, the data structure of the data stream stored on the optical disk 131 will be described with recording and playback functions mentioned and then the transfer function will be described. It should be noted that the data processor 10 is supposed to have these three functions just for the sake of convenience of description. Rather the data processor 10 has only to have the transfer function to be described in detail later, and may or may not have the recording and playback functions.

First, those components of the data processor 10 for realizing the recording function thereof will be described. The data processor 10 includes a video signal receiving section 100, an encoded data generating section 101, an audio signal receiving section 102, an input digital interface section 103, a management file generating section 106, a writing control section 115, a continuous data area detecting section 116, a logic block management section 117, a writing section 119 and an optical pickup 130.

The video signal receiving section 100 receives a video signal. The video signal may be a non-compressed and non-encoded digital signal representing a still picture or moving pictures, which has been supplied from the imager (CCD) of a digital still camera, or an analog signal of a televised wave, for example. The audio signal receiving section 102 receives an audio signal concerning audio. The audio signal may be a signal output from a microphone while moving pictures are being shot, for example. The video signal receiving section 100 and audio signal receiving section 102 are described herein so as to receive the video signal and the audio signal independently of each other. However, the present invention is also applicable effectively to even a situation where the video signal and audio signal are compressed, encoded and multiplexed digital broadcast signals. In receiving a digital broadcast signal, a single receiving section may be provided and the processing to be done by the encoded data generating section 101 described below may be omitted. The following preferred embodiments will be described on the supposition that the video signal receiving section 100 and audio signal receiving section 102 receive signals representing moving pictures and their accompanying audio, respectively. Both the video signal and audio signal will be regarded as signals in an analog format that have not been digitally compressed and encoded.

The encoded data generating section 101 encodes the video signal and audio signal in predetermined encoding formats (e.g., in the MPEG2-Video and AC-3 formats, respectively). Alternatively, the encoded data generating section 101 may generate data complying with the format to be adopted during writing. For example, the encoded data generating section 101 may divide the encoded video and audio data into data units complying with the respective recording formats and add a header and so on thereto, thereby making video packs and audio packs. Also, the encoded data generating section 101 generates RDI packs in performing a VR-compliant recording operation and generates navigation packs in performing a Video-compliant recording operation, respectively. Furthermore, the encoded data generating section 101 generates auxiliary information packs U_PK in the MP4 file format as will be described later.

The input digital interface section 103 (which will be referred to herein as an “input D-IF section 103”) is connected to an external device and receives a digital signal from the device, thereby acquiring a file of digital data. The “external device” may be the DVD recorder 20 or a PC (personal computer), for example. The input D-IF section 103 acquires a still picture data file for a still picture, an MPEG data file for moving pictures, and an AC3 data file for audio, respectively. The input D-IF section 103 is a digital interface such as an IEEE 1394 interface or a USB (universal serial bus) interface.

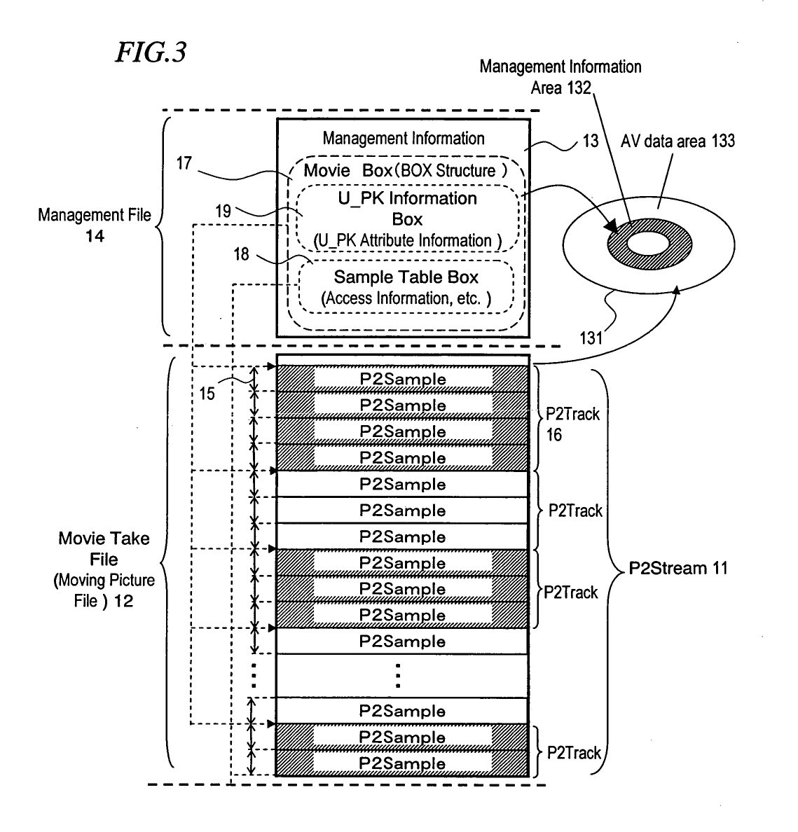

The management file generating section 106 generates a management file compliant with the MP4 file format in accordance with the result of encoding processing that has been performed by the encoded data generating section 101. FIG. 3 illustrates an exemplary management file 14 as will be referred to later. In the management file, attribute information, specifying the format of the data stream stored in a moving picture file, is described.

The writing section 119 gets the file written by the pickup 130 on the optical disk 131. This write operation is controlled by the writing control section 115. In accordance with the instruction given by the writing control section 115, the continuous data area detecting section 116 checks the availability of sectors, which are managed by the logic block management section 117, thereby detecting a physically continuous empty area available. As a result, the management file is written on a management information area 132, to which a predetermined amount of data is assigned from the inner edge of the optical disk 131, while the moving picture file is written on an AV data area 133, which is provided outside of the management information area 132. By arranging the management file exclusively on the inside portion of the disk, faster access and quicker readout are realized.

Hereinafter, the data structures of files written on the optical disk 131 will be described with reference to FIGS. 3 through 6. FIG. 3 shows the data structures of a moving picture file 12 and a management file 14 that are stored on the optical disk 131. The moving picture file 12 and management file 14 shown in FIG. 3 were recorded so as to comply with the MP4 file format. The MP4 file format is defined by the MPEG-4 system standard (ISO/IEC 14496-1), can deal with stream data, and is highly compatible with a PC. In the MP4 file format, moving picture streams compliant with VR, Video and various other standards can be recorded.

The MP4 file format is defined based on the QuickTime™ file format of Apple Corporation, and is a promising format because it is currently supported by various PC applications. The QuickTime file format, which forms the basis of the MP4 file format, is now used extensively as a file format for handling moving pictures and audio in the fields of PC applications.

On the optical disk 131, a moving picture file 12, including a moving picture stream (P2 Stream) 11, and a management file 14, including management information 13, are stored. The moving picture file 12 is written on an AV data area 133 of the optical disk 131, while the management file 14 is written on the management information area 132 of the optical disk 131. The moving picture file 12 will also be referred to herein as a “Movie Take File”.

The moving picture stream 11 may be a system stream as defined by the MPEG-2 system standard (ISO/IEC 13818-1), for example. Three types of system streams, namely, a program stream (PS), a transport stream (TS) and a PES stream, are defined. However, the MPEG-2 system standard defines no data structure to store the management information (including access information, special playback information and recording date/time information) for these system streams. In the following description, the moving picture stream 11 is supposed to have been compressed and encoded as an MPEG program stream.

The moving picture stream 11 includes a plurality of samples (P2 Samples) 15. Each of these samples 15 is composed as a mixture of video data and audio data and may be defined by the video playback duration, the amount of data (or data size) or any other parameter. For example, each sample 15 may include video data in an amount corresponding to a video playback duration of about 0.4 to 1 second as in a video object unit (VOBU) in a DVD. A set of one or more samples 15 will be referred to herein as a “track (P2Track) 16”.

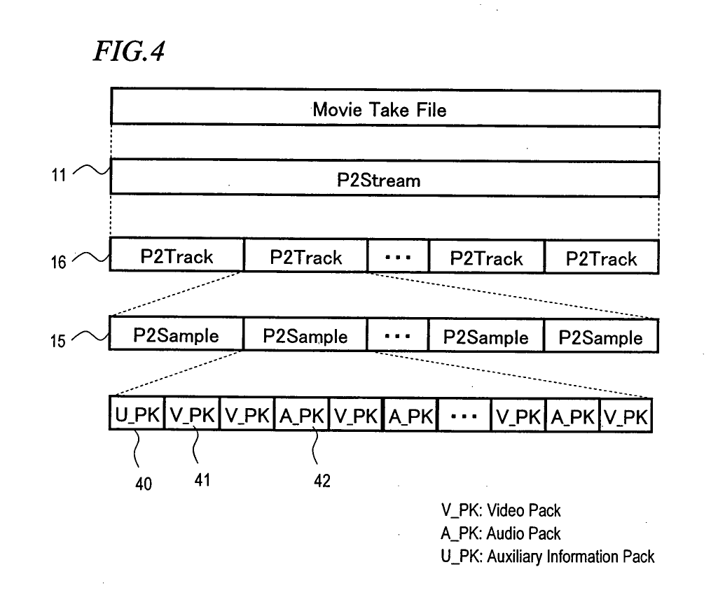

FIG. 4 shows a more detailed data structure of the moving picture stream 11. Each sample 15 includes one auxiliary information pack U_PK 40 at its top, which is followed by a plurality of video packs such as a video pack V_PK 41 and a plurality of audio packs A_PK such as an audio pack A_PK 42. It should be noted that the auxiliary information pack 40 may not be included in every sample.

Each pack includes a pack header and PES packets in which the auxiliary information and video and audio data are stored. Each and every pack has a constant data size of 2,048 bytes. The following description will be focused on the structure of the auxiliary information pack and the contents of information stored in the pack.

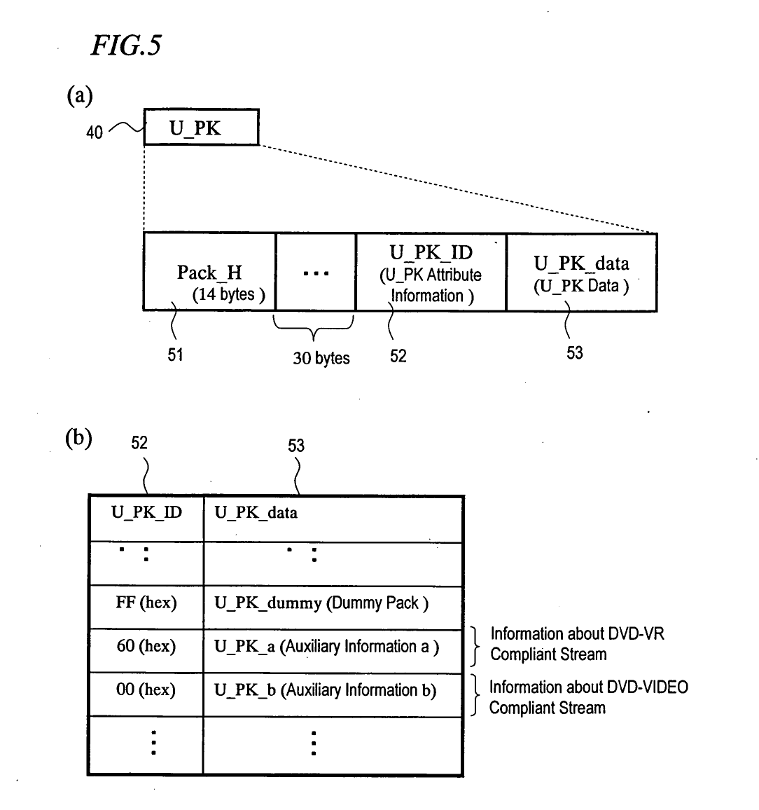

FIG. 5(a) shows the data structure of the auxiliary information pack 40. The auxiliary information pack 40 includes a pack header 51 at its top, attribute information U_PK_ID 52 showing the attribute of the moving picture stream 11, and attribute data U_PK_data 53. In the pack header 51, information that identifies this as the pack header 51 among various packs is described. The attribute information U_PK_ID 52 describes information that shows which of the two recording standards the data stored in the sample 15 complies with. As shown in FIG. 5(a), the attribute information 52 is stored at the 45^{th} byte and on as counted from the top of the auxiliary information pack 40. Thus, the converting section 121 of the data processor 10 (to be described later) can find its storage location and can retrieve the information. On the other hand, the attribute data U_PK_data 53 describes information about the recording standard specified by the attribute information U_PK_ID 52, e.g., information about the aspect of the encoded video stream.

FIG. 5(b) shows correspondence between the ID of the attribute information 52 and the contents of the attribute data U_PK_data 53 described according to the ID. The attribute information 52 may have IDs represented as hexadecimal numbers such as “00”, “60” and “FF”. And data associated with that ID is described as the attribute data 53. For example, if the sample 15 includes a VR-compliant moving picture stream, then the ID “60” is added and auxiliary information a about the VR-compliant stream is described as the attribute data U_PK_data 53. On the other hand, if the sample 15 includes a Video-compliant moving picture stream, then the ID “00” is added and auxiliary information b about the Video-compliant stream is described as the attribute data U_PK_data 53. Thus, it can be seen by the value of the attribute information 52 which recording standard the moving picture stream of the sample 15 complies with.

The management information 13 will be described with reference to FIG. 3 again. The management information 13 includes access information that designates a storage location on a sample-by-sample basis. The access information and other pieces of information are described in Sample Table Box 18 in Movie Box 17 within the management information 13. In other words, the sample is managed as the minimum management unit in the Sample Table Box 18 and the access information representing the data storage location and so on is described for each sample. It should be noted that the “sample” 15 and “track” 16 are just units of the moving picture stream 11 to be managed with the management information 13 and the data of the moving picture stream 11 is not always defined as physically divided ones. Optionally, in the management information 13, access information may be defined for each track 16. The encoded data generating section 101 generates the moving picture stream (P2stream) 11 such that its data structure matches the structure described above.

In the QuickTime file format, a structure called “Atom” is adopted and is quite similar to the structure called “Box” described above. Thus, if the term “Box” is replaced with the term “Atom”, then this description about the MP4 file format also applies to the QuickTime file format, too.

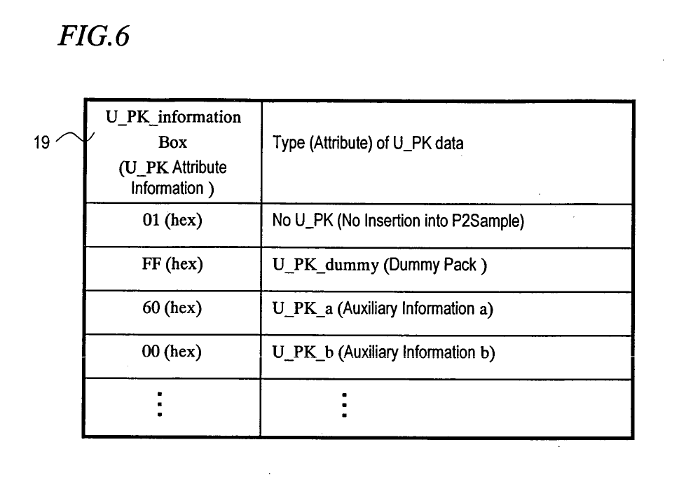

Meanwhile, the management information 13 includes a U_PK attribute information box (U_PK information box) 19. In the U_PK attribute information box 19, the same ID as that stored in the U_PK attribute information 52 (see FIG. 5(a)) is copied and stored. Alternatively, the same data as the U_PK data 53 shown in FIG. 5(a) may be stored in the U_PK attribute information box 19. FIG. 6 shows the types of IDs described in the U_PK attribute information box 19 and their associated types of U_PK stored data. This is substantially the same as the correspondence between the ID of the attribute information 52 and the contents of the attribute data U_PK_data 53 described for the ID as shown in FIG. 5(b). Thus, the description thereof will be omitted herein. The management file generating section 106 generates the management information 13 such that the management information 13 matches the data structure described above.

Next, respective components of the data processor 10, which perform its playback function, will be described with reference to FIG. 2 again. The data processor 10 includes a video signal output section 110, a decoding section 111, an audio signal output section 112, a reading section 113, a reading control section 114, a management information retaining memory 118, and the pickup 130.

The reading section 113 gets the data on the optical disk 131 read by the pickup 130 and acquires it as digital data. This read operation is carried out in accordance with the instruction of the reading control section 114. Before giving the instruction to read that data, the reading control section 114 instructs the reading section 113 to read the management information file 14 from the management information area 132 of the optical disk 131. The management information retaining memory 118 retains the management information 13 extracted from the management file 14 that has been read. After having been instructed to read the data, the reading control section 114 finds the storage location in the AV data area 133 in accordance with the access information in the Sample Table Box 18 in the management information retaining memory 118. The pickup 130 and reading section 113 read a sample 15, of which the storage location has been found.

The decoding section 111 receives the compressed and encoded video and/or audio data and performs a decoding process thereon according to the compression format, thereby outputting video data and/or audio data. In response, the video signal output section 110 and audio signal output section 112 output the decoded video signal and/or audio signal, respectively, to a TV and a loudspeaker, for example.

Next, respective components of the data processor 10, which performs its function of transferring a data stream, will be described. To perform the transfer function, the data processor 10 includes a converting section 121 and an output digital interface section 122.

The converting section 121 operates in accordance with the decision made by the reading control section 114 about whether or not the format should be converted as will be described later. If it is determined that the format need not be converted, then the converting section 121 outputs the moving picture stream 11 as it is without converting it at all. On the other hand, if it is determined that the format should be converted, then the converting section 121 converts the recording format of the moving picture stream 11 stored in the AV data area 133 on the optical disk 131 into that specified by the reading control section 114. For example, if the moving picture stream 11 has a VR-compliant data structure and if the management file is stored in the MP4 file format, then the converting section 121 decodes the moving picture stream 11 once, compresses and encodes the stream again such that the stream has a format complying with the Video standard, and then outputs the resultant stream. Alternatively, the management file may be converted from the MP4 file format into the Video standard in some cases. This means that if the management file has a different file structure, the management file also needs to be converted.

As another alternative, other conversion processes may also be done. Both a VR-compliant moving picture stream and a Video-compliant moving picture stream include a plurality of video objects (VOBs), each of which consists of a plurality of video object units (VOBUs). The VOBU corresponds to the sample 15 (i.e. P2 sample) shown in FIG. 4. Each VOBU includes video packs storing video data and audio packs storing audio data. Thus, the converting section 121 may use the respective packs compliant with the VR standard as packs compliant with the Video standard as they are.

Meanwhile, the converting section 121 converts a real time information pack (RDI pack) arranged at the top of a VOBU compliant with the VR standard into a navigation pack (navi pack) compliant with the Video standard. Both of these packs contain information for controlling the playback of video data and audio data in a moving picture stream and have data structures defined by their respective standards. Also, the converting section 121 converts the first video pack and the first audio pack of each top VOBU compliant with the VR standard into a video pack and an audio pack having no PES extension fields. However, the video pack and audio pack that appear first in a VOB are not converted but left as they are. In performing the conversion, the PES extension field may be deleted and the data length may be adjusted to a fixed pack length of 2,048 bytes. In the PES extension field, information needed for decoding a program stream (e.g., the capacity of a decoding data buffer) may be described. According to this processing technique, not all video data and audio data need to be decoded or compressed and encoded again. As a result, the processing can be speeded up and the deterioration of quality can be minimized.

Next, the output digital interface section 122 (which will be abbreviated herein as the “output D-IF section 122”) receives a moving picture stream and then outputs the moving picture stream in compliance with a communication protocol defined by the IEEE 1394 standard, for example. In FIG. 2, the output D-IF section 122 and the input D-IF section 103 are shown as separate ones. However, these are illustrated as different ones just for the sake of description and may be combined into a single one, too. For example, in an IEEE 1394 interface, data may be input and output through just one connector.

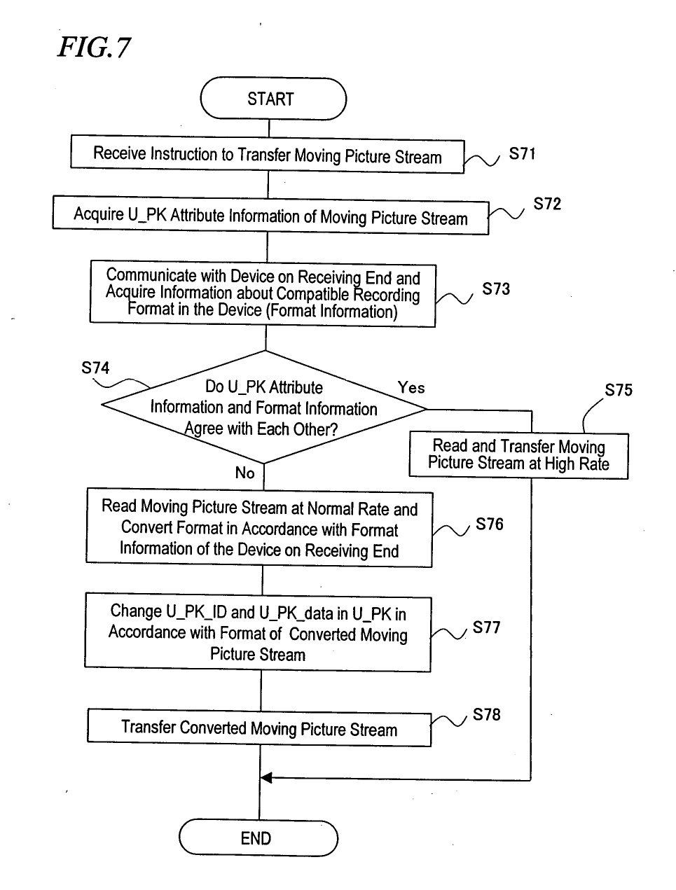

It should be noted that to transfer a data stream, the data stream needs to be read out from the optical disk 131. To read the data stream, the reading section 113, reading control section 114, management information retaining memory 118 and pickup 130 are needed as in the playback operation. These components operate almost as already described for the playback function of the data processor 10. The differences will be described next with reference to FIG. 7 along with the procedure of the processing done by the data processor 10.

FIG. 7 shows the procedure of the transfer process to be done by the data processor 10. First, before the process is started, the user connects the output digital interface section 122 (to be described later) of the data processor 10 to the input terminal of the DVD recorder 20 with an IEEE 1394 compliant cable, for example, and inputs an instruction to transfer a data stream to the DVD recorder 20 by using a remote controller (not shown) of the data processor 10, for instance. Then, in Step S71, the reading control section 114 of the data processor 10 receives the instruction to transfer a moving picture stream 11. On receiving this instruction, the reading control section 114 acquires the U_PK attribute information 19 from the management information retaining memory 118 in the next processing step S72, thereby identifying the format of the moving picture stream 11. In this example, the moving picture stream 11 has a VR-compliant format.

Next, in Step S73, the output D-IF section 122 inquires the DVD recorder 20 as the drive on the receiving end, and the input D-IF section 103 acquires the information about the format that makes the moving picture stream recordable or playable by the DVD recorder 20 (which will be referred to herein as “format information”). The format information is sent to the reading control section 114.

For example, the data processor 10 may acquire the format information from the DVD recorder 20 in compliance the IEEE 1394 communication protocol. Alternatively, the data processor 10 may also detect the format information of the DVD recorder 20 by using a communication protocol defined by the HDMI standard. More specifically, the data processor 10 transmits a control command to the DVD recorder 20 in accordance with the HDMI standard to request device identity information showing the name of manufacturer, the model and so on, and receives the device identity information from the DVD recorder 20 in compliance with the HDMI standard, too. Then, the reading control section 114 makes reference to a table that is stored in an internal memory of the data processor 10 or an external memory card (not shown). In the table, correspondence between the device identity information and the format information of that device is described. In accordance with these pieces of information, the reading control section 114 can collect the information about the format compatible with the DVD recorder 20. Optionally, the reading control section 114 may acquire, as the format information, the format name that has been input by the user with the remote controller.

Next, in Step S74, the reading control section 114 determines whether or not the U_PK attribute information 19 and format information agree with each other. In this preferred embodiment, the U_PK attribute information 19 shows that the stream has the VR-compliant format. Accordingly, if the format information also shows the VR-compliant format, then the reading control section 114 determines that no conversion needs to be done and the process advances to Step S75. On the other hand, if the format information shows a format other than the VR-compliant format (e.g., the Video-compliant format), then the reading control section 114 determines that the conversion should be done and the process advances to Step S76.

In Step S75, the data processor 10 spins the optical disk 131 at a velocity that is several to several tens of times as high as the read rate during a normal playback operation, thereby getting the moving picture stream 11 read by the pickup 130 and reading section 113 at a rate that is several to several tens of times as high as the read rate during a normal playback operation. Such processing can be carried out because the converting section 121, to which the moving picture stream 11 has been transmitted, need not convert the stream and there is no need to wait until the converting section 121 finishes its processing. Once the moving picture stream 11 has been read, the converting section 121 sends the moving picture stream 11 as it is to the output D-IF section 122, which also transfers the moving picture stream 11 as it is to the DVD recorder 20. When the transfer is done, the processing ends.

In Step S76 on the other hand, the pickup 130 and reading section 113 read the moving picture stream from the optical disk 131 at a normal rate, and the converting section 121 converts the format in accordance with the format information of the DVD recorder 20 as the drive on the receiving end. Furthermore, in Step S77, the converting section 121 changes the U_PK attribute information (U_PK_ID) 52 and U_PK_data 53 in the auxiliary information pack (U_PK) 40 in accordance with the format of the converted moving picture stream. Thereafter, in Step S78, the output D-IF section 122 transfers the converted moving picture stream to the DVD recorder 20. The DVD recorder 20 can receive the converted moving picture stream and record it on the storage medium 134 as it is. Thus, no conversion processing load is placed on the DVD recorder 20 and its hardware resource can be used effectively for other purposes.

In the preferred embodiments of the present invention described above, the optical disk 131 is supposed to be a DVD-RAM disk. As to optical disks, however, there are various standards. Thus, the DVD-RAM disk may be replaced with an MO, a DVD-R, a DVD-RW, a DVD+RW, a CD-R or a CD-RW. It should be noted that the storage medium may be a removable storage medium other than the optical disk 131 (e.g., a semiconductor memory card) and may also be a hard disk, a semiconductor memory or any other component that forms an integral part of the data processor 10.

Also, in the preferred embodiment described above, the MP4 file format is supposed to be used such that the U_PK attribute information 19 is stored in one (i.e., U_PK Information Box) of the movie boxes that are BOX structures. However, such a BOX structure is not an essential requirement for the present invention. Alternatively, any other data structure may be adopted as long as the U_PK attribute information is included in management information so as to be easily retrievable from it.

In the foregoing description of the MP4 file format, the moving picture file 12 and management file 14 are supposed to be stored as two separate files on the optical disk 131. However, this is not an essential requirement for the present invention, either. For example, only the moving picture file 12 may be stored there by itself. In transferring the moving picture stream described above, the reading control section 114 may read the U_PK attribute information 52 directly from the auxiliary information pack 50 of the moving picture stream 11 that is stored as the moving picture file 12 to identify the format of the moving picture stream 11.

If either the format information of the DVD recorder 20 or the attribute information specifying the format of the data stream is fixed (e.g., if it is known in advance that only a device accepting processing in one particular format can be connected to the data processor 10 or if the format of the data stream is defined in advance and the attribute information is fixed), then the reading control section may determine, by at least one of the attribute information and format information, whether or not the format of the data stream should be converted.

The transfer function of the data processor is realized by executing a computer program that defines the processing procedure shown in FIG. 7. By executing such a computer program, a computer including the data processor operates the respective components of the data processor and performs the processing described above. The computer program may be circulated on the market by being stored on a storage medium such as a CD-ROM or downloaded over telecommunications lines such as the Internet. As a result, even a computer system can also perform a transfer process just like the data processor described above.

### INDUSTRIAL APPLICABILITY

According to the present invention, when a data stream is transferred, it is determined whether or not the data stream has a format that is compatible with the device on the receiving end. If the answer is YES, the data stream is transferred as it is without being processed at all. Otherwise, the data stream is converted into a compatible format and then transferred. When the data stream is transferred without being processed, there is no limit on the read rate of the data stream. Thus, the data stream can be read out from the storage medium and transferred at high speed. And the device in the receiving end may record the received data stream as it is. Consequently, the processing load on the device on the receiving end due to the conversion process, for example, can be reduced.

1. A data processor for transferring a data stream to a connected device, the data stream including video data, audio data and management data to control playback of the video data and audio data and being stored in a first format on a storage medium, the data processor comprising:
an interface section, which communicates with the device to acquire format information about a second format that is compatible with the device;
a reading section for reading the data stream from the storage medium;
a reading control section for determining, based on the format information, whether or not the format of the data stream needs to be converted; and
a converting section for outputting the data stream either after having converted the first format of the data stream into the second format or without converting the format of the data stream as determined by the reading control section,
wherein the interface section transmits the data stream, which has been output from the converting section, to the device.

2. The data processor of claim 1, wherein the converting section changes the management data of the data stream into management data that is compatible with the second format, thereby converting the first format of the data stream into the second format.

3. The data processor of claim 2, wherein the converting section converts the format of the data stream into the second format without altering the video data and the audio data themselves.

4. The data processor of claim 1, wherein the reading section changes the read rates of the data stream depending on whether or not the format needs to be converted.

5. The data processor of claim 4, wherein the reading section reads the data stream at a first rate if the format needs to be converted, but reads the data stream at a second rate, which is higher than the first rate, if the format need not be converted.

6. A data processing method to be carried out by a data processor for transferring a data stream to a device that is connected to the data processor, the data stream including video data, audio data and management data to control playback of the video data and audio data and being stored in a first format on a storage medium, the method comprising the steps of:
communicating with the device to acquire format information about a second format that is compatible with the device;
reading the data stream from the storage medium;
determining, based on the format information, whether or not the format of the data stream needs to be converted; and
outputting and transmitting the data stream to the device either after having converted the first format of the data stream into the second format or without converting the format of the data stream, in accordance with the result of the step of determining.

7. The data processing method of claim 6, wherein the step of outputting includes changing the management data of the data stream into management data that is compatible with the second format, thereby converting the first format of the data stream into the second format.

8. The data processing method of claim 7, wherein the step of outputting includes converting the format of the data stream into the second format without altering the video data and the audio data themselves.

9. The data processing method of claim 6, wherein the step of reading includes changing the read rates of the data stream depending on whether or not the format needs to be converted.

10. The data processing method of claim 9, wherein the step of reading includes reading the data stream at a first rate if the format needs to be converted, but reading the data stream at a second rate, which is higher than the first rate, if the format need not be converted.
